(19) United States
(12) Patent Application Publication
(10) Pub. No.: US 2015/0040174 A1
(43) Pub. Date: Feb. 5, 2015

(54) SYSTEM AND METHOD FOR SYNCHRONIZING MEDIA PLATFORM DEVICES

(71) Applicant: JOIZ IP AG, Zurich (CH)

(72) Inventors: Alexander Mazzara, Zurich (CH); Mathias Menzl, Zurich (CH); Dominik Stroppel, Zurich (CH)

(21) Appl. No.: 14/341,110

(22) Filed: Jul. 25, 2014

Related U.S. Application Data
(60) Provisional application No. 61/860,994, filed on Aug. 1, 2013.

(51) Int. Cl. H04N 21/242

(52) U.S. Cl. CPC H04N 21/242
USPC 725/116

(57) ABSTRACT

Disclosed is a system and method for receiving a broadcast, associating the broadcast with a broadcast device and a time interval, transmitting the broadcast to the broadcast device during the time interval, transmitting a message to a user device during the time interval, receiving a response to the message from the user device during the time interval, and determining a match between the response and the transmitted broadcast.

### RELATED APPLICATIONS

The present application claims the benefit of U.S. Provisional Application Ser. No. 61/860,994, titled “joiz Red Button,” filed on Aug. 1, 2013, the entire contents of which are herein incorporated by reference.

### TECHNICAL FIELD

Aspects and implementations of the present disclosure relate generally to a system and method for synchronizing devices across different media platforms. More specifically, aspects and implementations of the present disclosure relate to a system and method for synchronizing devices across different media platforms, such as a broadcast signal (e.g., a TV signal or a set of interactions on a website), a display (e.g., a television display or a stadium display screen and the like) and a mobile device (e.g., a smart phone) or any other type of responsive device (e.g. Kinnect™ or other gesture-based interaction technologies, Google™ glasses, smart watches, etc.) that can transmit a user response and can also connect to an analytics system or to a user management system.

### BACKGROUND

Mobile phones (e.g., smart phones), television programs, Internet, and Social Media are ubiquitous media platforms in today's society. Most prior approaches to integrating these platforms have been limited to operations within the same platform (i.e. TV solutions only work for interaction within TV set environment, web solutions only within a browser, mobile only within an app).

Recent solutions, such as Shazam™, which is a mobile application that recognizes music and media, allows a user to retrieve data according to an audio-signal which is being listened to. However, such solutions do not provide for interaction with third-party service providers such as television broadcast programs or proprietary broadcast web sites. Thus, interaction with platforms such as Facebook™, Twitter™, or the proprietary broadcast sites such as those of the FIFA™ and the NBA™, cannot be handled by the present types of solutions. What is needed is a system and method to integrate and synchronize multi-media use cases as they arise from today's media consumption habits.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is an example block diagram of a system for enabling the synchronization of devices across different media platforms in accordance with embodiments of the present disclosure;

FIG. 2 is an example block diagram a system for enabling the synchronization of devices across different media platforms in accordance with embodiments of the present disclosure;

FIG. 3 is an example flow diagram for enabling the synchronization of devices across different media platforms in accordance with embodiments of the present disclosure; and

FIG. 4 is a block diagram of a computer system that may perform one or more of the operations described herein.

### DETAILED DESCRIPTION

Embodiments of the disclosure include a system and method that can provide a solution to the challenges faced today in stimulating and measuring engagement with linear content. As used herein, the terms “broadcast”, “linear content”, and “linear broadcast” are intended to include a media presentation such as a TV broadcast signal, a streaming video or audio presentation from a web site, a cinema presentation, a video presentation at a public event, an audio recording, and the like. In an embodiment, the broadcast, linear content, or linear broadcast can include a media presentation in which the viewer does not have navigational control. Embodiments of the disclosure can allow broadcasters, advertisers, live event organizers, and other types of content distributors to trigger and analyze user interaction with content or media presentations across different platforms. The disclosure can track multi-screen engagement and can provide for a synchronized, unified, and interactive user experience across different content channels.

This real-time user feedback and interaction enabled by implementations of this disclosure can be applicable to, but not limited to, advertising (e.g. to provide more transparency on the impact of radio, TV or outdoor display ads), live events (e.g. in order to engage the audience) and other content types of events where real-time interaction can be solicited via a second screen.

Within the TV broadcasting environment, the present disclosure illustrates a system and method for synchronizing a back-end device, a front-end broadcast device, and a user device. For example, the present disclosure can synchronize the activation timeframe on a website and the airing of a notifier (such as a red button) on linear TV. The delay of a standard TV-signal, a digital TV-signal, a satellite TV-signal, a web-stream or any other distribution form can vary significantly and are taken into consideration by disclosed synchronization method.

TV broadcasting systems provide a means to deliver content as well as ordinary television audio and video to a large number of subscribers (e.g., 1 to N). Programs that broadcast by these systems may incorporate television audio and video, still images, text, graphics and applications, and many other components. The present disclosure allows any sender of a trigger to gather data and click-through-rates of the N participants.

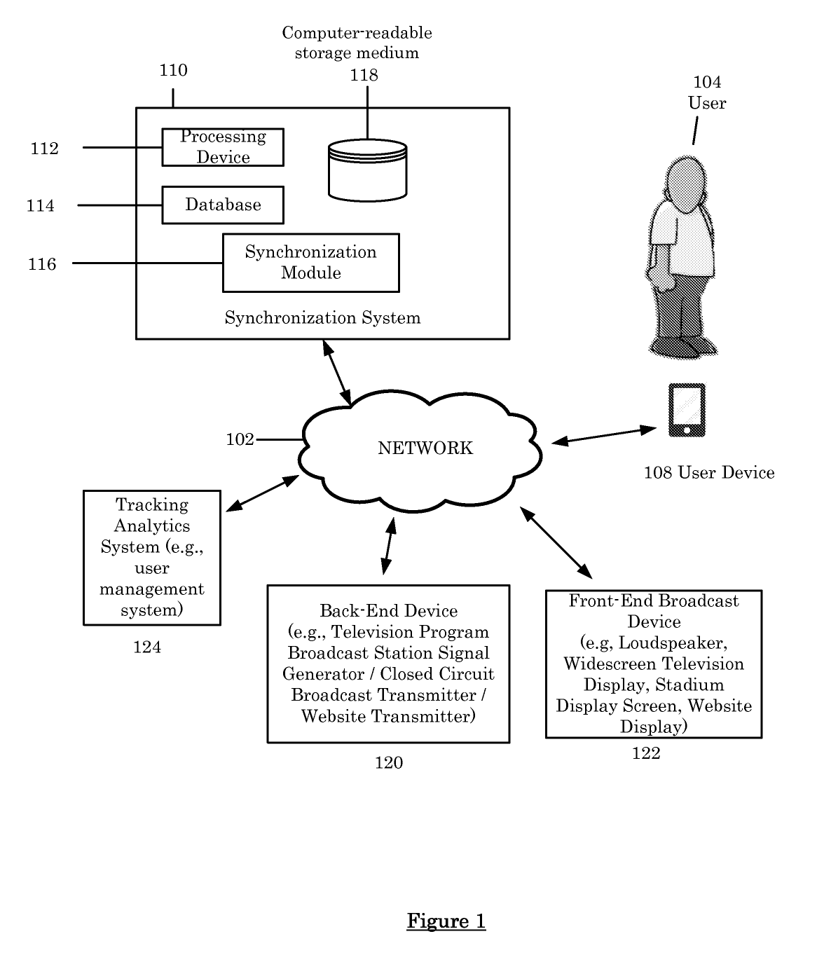

FIG. 1 illustrates a block diagram of an exemplary environment including a synchronization system 110 for enabling the synchronization of devices across different media platforms, a user device 108. A back-end device 120, a front-end broadcast device 122, and a tracking analytics system 124. It is noted that throughout this disclosure, the synchronization system 110 can be referred to as the “joiz Red Button™” system, however, it is understood that the synchronization system 110 can be referred to by other names.

The synchronization system 110 includes a processing device 112 (such as a computer, a server, a processor, etc.) for determining, tracking, and managing different devices across different media platforms in accordance with an embodiment of the present invention. The synchronization system 110 can be used to inform a user 104 of a certain marketing or promotional activity that can occur within the range or vicinity of a user device 108 operated by the user. As used herein, the user device 108 can be any device capable of communicating with the synchronization system 110 via a network 102 (e.g., the Internet, satellite, or the wired or wireless telephone network) or via a wireless connection (e.g., a wireless local area network). The network 102 may be any type of communications medium that allows for communication between the synchronization system 110 and the user device 108. The user device 108 can include, but is not limited to, a tablet device such as the Apple® iPad, a computer, a smart phone, a wireless device, and/or any suitable computing device.

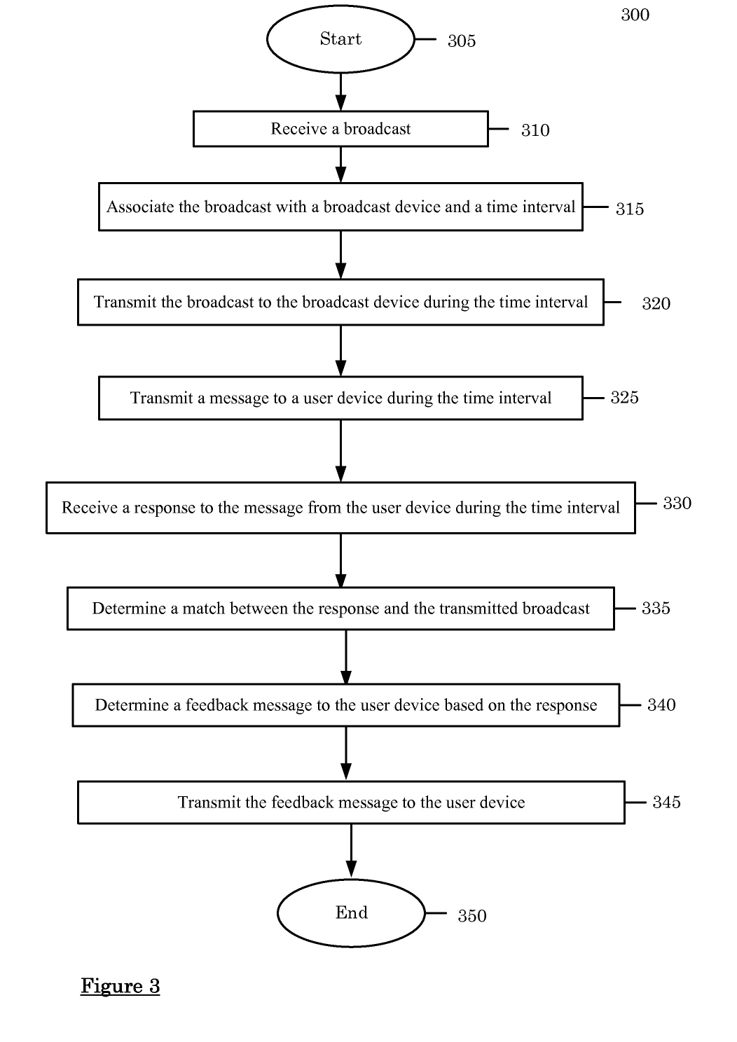

In an embodiment, the synchronization system 110 may include a synchronization module 116 for providing processing logic or computer instructions for the synchronization of devices across different media platforms, and for notifying a user of a marketing or advertising program within a certain range of the user device 108. As used herein, the synchronization module 116 may be a computer program or processing logic including one or more sets of instructions provided to implement method 300, as described below in connection with FIG. 3.

In an embodiment, the synchronization module 116 may be implemented by the processing device 112 for providing a system and method for the synchronization of devices across different media platforms. As used herein, the term “processing device” is intended to include a programmable electronic machine or a processing device that performs and/or executes software to perform several operations such as assemble, store, correlate, or otherwise process information. The synchronization module 116 can include processing logic for receiving the GPS coordinates of the user device 108 and comparing it to the location of a certain marketing or advertising promotional activity.

The synchronization system 110 may also include a database 114. As used herein, the term “database” refers to a repository for containing and storing data. The data that is stored in database 114 may be related to the data for synchronizing devices across different media platforms. The data can also include the GPS coordinates of addresses of certain marketing or advertising promotional activities. The data can also include the current GPS coordinates of a respective user device 108 that is associated with a user 104.

The synchronization system 110 may also include a non-transitory computer-readable storage medium 118, such as a hard drive, for storing the database 114 and a wireless device and/or an Internet interface (not shown) that allows for communication with any type of consumer device. The synchronization system 110 is configured to communicatively connect to one or more user devices 108 via the network 102 (e.g., the Internet, or the wired or wireless telephone network).

The back-end device 120 can be any device, such as a television broadcast station signal generator or a closed circuit broadcast transmitter that can push or transmit a broadcast or a liner content signal to a front-end broadcast device 122, such as a loudspeaker, a computer monitor, a widescreen television display or a stadium display screen, and the like, in synchronization with the same push or transmission to the user device 108. In addition, the back-end device can integrate a marker or trigger with the linear content using parameters such as activation time-frame, feedback and notification-parameters. The integration of the marker or trigger with the certain broadcast or linear content can be referenced back to a user device 108 that is associated with the user 104 (e.g., the viewer, listener, etc.) via, for example, a connection to a user database (not shown) or to the tracking analytics system 124. The tracking analytics system 124 can be a system that monitors, tracks, and analyzes the location of a specific user in relation to the location of a specific marketing or advertising event. Thus, a specific user 104 can be targeted with specific content or can be targeted to be notified during a specific event.

The actions that a user 104 can perform via the user device 108 can be synchronized to the trigger or marker, which can be defined in the back-end device 120 to perform a call to action at the front-end broadcast device 122. The synchronization system 110 can synchronize the back-end device 120, the front-end broadcast device 122, and user device 108 in order to enable a user 104 or multiple users perform a set of actions which are being defined by the synchronization system 110. Both the interactive content and the linear content (e.g. audio and/or video data) can be delivered to the user 104 or subscribers as synchronized “pushed” data. As such, the data can be delivered to each user device 108 associated with a respective user 104, regardless of whether or not the user 104 has requested the data. Actions, events, and responses can be tracked by the tracking analytics system 124 and associated with unique user 104. In an embodiment, the synchronization system 110 can be configured to connect to and interact with different back-end devices 120, front-end broadcast devices 122, user devices 108, user-databases, and tracking/analytics-systems 124.

In an embodiment, the interactive “joiz Red Button™” system or synchronization system 110 can synchronize a back-end device 120, a front-end broadcast device 122, and a user device 108 in real time or during the actual time of occurrence such that the synchronization system 110 can process a request from an administrator upon receipt. The synchronization system 110 can include application code, data associated with the audio and video, control signals, raw data and other types of information. Both the interactive content and the audio and video data may be delivered to subscribers as synchronized “pushed” data. Therefore, the data can be delivered to each of the subscribers regardless of whether or not the subscribers requested the data (pull) and all can be pushed synchronized.

In an embodiment, the “joiz Red Button™” system or synchronization system 110 can be a campaign-system which is integrated in the back-end of a tv-channel or different tv-channels or different play-outs. These channels can offer their own applications (or apps) to interface with the user device 108. For example, if a user 104 sees an icon, such as a Red Button™, on Channel 4, he or she can be guided to the Channel 4 app. If a user 104 sees at the same time an icon, such as a Red Button™, on Channel 2, then he or she can be guided to the Channel 2 app. In another example, if a user 104 sees an icon, such as a Red Button™, on a front-end broadcast device 122 for an advertisement for Coca-Cola™ on a wide screen TV at the certain train station, the user 104 can be guided to the correct front-end application, for example, a Coca-Cola™ application in order to get the user to the correct application. Similarly, if a user 104 is at a sporting event and sees an icon such as a Red Button™ on a front-end broadcast device 122 for an advertisement activity or a promotional activity, the user 104 can be guided to the correct app that involves the app of a sports team.

In an embodiment, the “joiz Red Button™” system or synchronization system 110 can establish multiple distinct events and multiple distinct environments to allow users that are associated with a certain event or environment to interact with the program that is associated with the event or environment. The synchronization system 110 can establish different campaign-systems for different channels and different clients.

For example at 1300 hours, an icon such as the Red Button™ can appear during a Coca-Cola™ advertisement on a front-end broadcast device 122 (such as a widescreen TV) at the Zurich train station, while at 1310 hours an icon such as the Red Button™ can appear during an advertisement for a Mini™ car on a different front-end broadcast device 122 (e.g., a widescreen TV at a sporting event in Basel). The “joiz Red Button™” system or synchronization system 110 can be configured to establish a first environment associated with the Coca-Cola™ ad on the front-end broadcast device 122 (i.e., the TV at the Zurich train station) and a second environment associated with the sporting event in Basel. The synchronization system 110 can reference a database to determine which users 108 are presently located in the proximity of the Zurich train station and which other users 108 are presently located in the proximity of the sporting event in Basel. The GPS location tracking of the different users 104 enables the synchronization system 110 to push the Red Button icon to only those user devices 108 that are at the located near the proximity of the Zurich train station at 1300 hours. Similarly, the synchronization system 110 can push the Red Button icon only to the user devices 108 that are present at the Basel sporting event at 1310 hours.

In the event that the two events are located in the same area, the synchronization system 110 can distinguish the different events according to the unique event-ids which can be generated while planning the marketing or advertising campaign.

In an embodiment, the “joiz Red Button™” system or synchronization system 110 can determine user devices 108 that are associated with certain users 104 to transmit or push the icon such as the Red Button™. For example, the synchronization system 110 can define certain preferences for a user 104, in the sense of targeting the transmission of the icon such as the Red Button™, or according to user-interests as specified on a user profile. In an embodiment, a user 104 could specify his or her preferences, for example in a user-profile of a specific TV broadcast station. In an embodiment, an administrator of the “joiz Red Button™” system or synchronization system 110 can define campaigns and a set of actions for a specific interface and can synchronize these campaigns and actions to a front-end broadcast device 122 and a user device 108.

In an embodiment, the “joiz Red Button™” system or synchronization system 110 can use an open platform that can be replicated in other systems. To deliver the icon or Red Button™ experience, the campaign management system can be configured to include standard analytics, content management and user management systems. Likewise, the trigger/marker tool and client parts of the synchronization system 110 can use one of the several products available for transmitting a marker/trigger with an audio or video-signal (e.g., watermarking, fingerprinting, etc.) and pulling additional meta-data to a running video/audio-signal.

The campaign message can include multiple triggers or markers and parameters, as identified by the administrator, according to which a user device 108 that is associated with a user 104 can receive a notification message or a set of notification messages. The user 104 can perform an action or a set of actions in response to receiving the notification message or the set of notification messages. In an embodiment, the notification message can be any icon. In an embodiment, the icon can be a red disc shaped figure, which is commercially known as the “joiz Red Button™.”

In an embodiment, a unique ID (e.g., a string) can be imported into the synchronization system 110 in which the parameters can be defined for actions that can occur after a user clicks the Red Button on the user device 108. For example, the string can function as a trigger for a graphic in an advertisement, as well as the trigger for the client, for example the red button in the application on the user device 108. The string can define which advertisement or program is presently running. If there are multiple advertisements or programs in a row and there are some overlapping-issues because of time-shifts, the user 104 can be queried to select which advertisement the user 104 wants to get the reward for. The query of the selection can be generated based on the string.

In an embodiment, the ID which was imported in the synchronization system 110 (e.g., the Campaign-System of the Red Button) and which may be enhanced with parameters, can be allocated to a certain segment/content in any playout-system possible.

In an embodiment, active IDs can be being pushed to any front-end broadcast device 122 (e.g., a widescreen at a basketball game, a TV-program, an advertisement-display at the airport, etc.) and at the same time (e.g., synchronized) with one or n clients (e.g., a mobile application on the iPhone or Android-Phone, or any Website possible).

In an embodiment, the aforementioned synchronization process can be visible as a call-to-action (e.g., with an integrated icon such as a red button graphic which can be displayed on the front-end broadcast device 122 (e.g., a widescreen display at the basketball-game) and at the same time displayed on a user device 108. In response, the user 104 may push or touch the button on the user device 108 to transmit a response to the client-side.

In an embodiment, the client may send the request to the user database, where it can be checked if the user 104 is logged in (this may only be necessary if the click should be traced back to a unique user 104). The client can send another request to the backend where it can determine what sets of actions should be performed. User actions can be tracked as an event and can be reported in an analytics-backend. In an embodiment, when a user needs to register and log in to perform the action, the action can be saved in a user-database that is communicably coupled to the synchronization system 110.

In an embodiment, the user can receive feedback from the backend on the client side. After the user clicked the icon (e.g., the “red button” on via the user device 108, the user 104 can receive feedback which has been defined in the campaign-system. This feedback can be planned in the campaign-system.

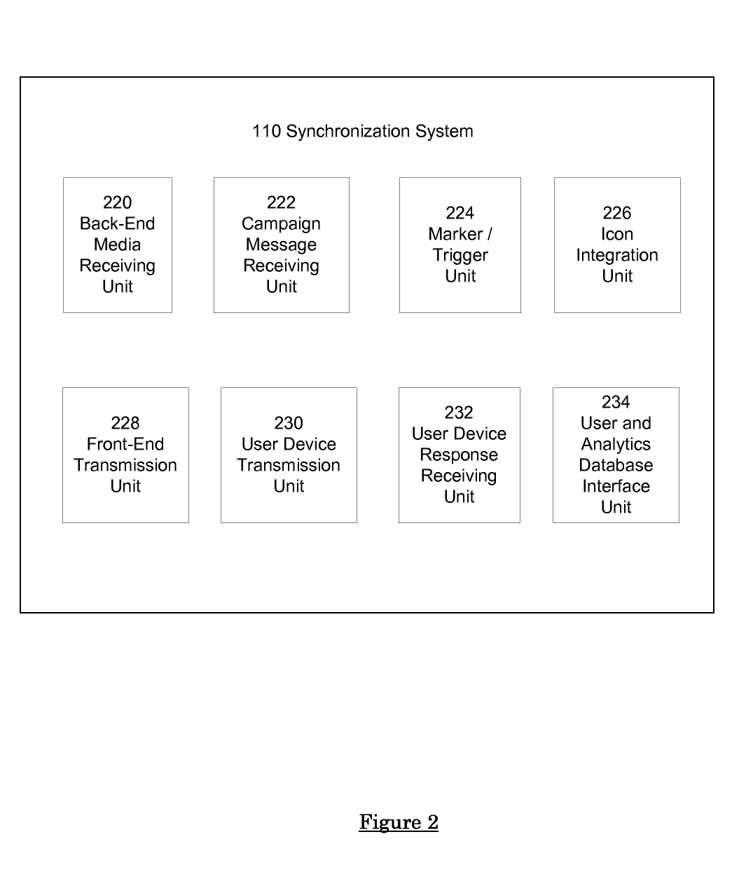

FIG. 2 is an example block diagram of a system for enabling the synchronization of devices across different media platforms in accordance with embodiments of the present disclosure. In FIG. 2, the synchronization system 110, of examples of this disclosure, can include a back-end media receiving unit 220, a campaign message receiving unit 222, a marker/trigger unit 224, an icon integration unit 226, a front-end transmission unit 228, a user device transmission unit 230, a user device response receiving unit 232, and a user and analytics database interface unit 234.

The back-end media receiving unit 220 can receive a “broadcast”, “linear content”, or “linear broadcast” from a transmitter. As discussed above, as used herein, the terms “broadcast”, “linear content” and “linear broadcast” are intended to include a media presentation in which the listener or viewer does not have interactive or navigational control. Examples of a broadcast include, but are not limited to, a standard television broadcast signal, a digital broadcast signal, a satellite broadcast signal, a web site streaming broadcast signal, a closed-circuit broadcast signal, a cinema broadcast signal, an audio broadcast signal, a display of a message, a display of an icon, an internet-protocol (IP) television signal, an IP video signal, an IP audio signal, a video broadcast signal, a progressive download streaming signal, and the like.

The campaign message receiving unit 222 can receive, from an administrator, a message to initiate a campaign. The campaign can be, among others, a marketing program or an advertising program. In an embodiment, the message can include a unique ID associated with the campaign. The unique ID can function as an identifier of a broadcast, which can trigger a graphic element such as an icon to be integrated with the broadcast. In an embodiment, the message can also include a display device (e.g., the front-end broadcast device 122) to transmit the broadcast integrated with the icon. In an embodiment, the message can also include a time interval for the campaign to occur and a target audience for the campaign. In an embodiment, the target audience can be used to identify certain users 104, and their respective associated user devices 108, to participate in the campaign.

The marker/trigger unit 224 can mark or apply a tag to an associated broadcast. The tag can indicate that the broadcast has been identified for a campaign, and is associated with a display device, a time interval, and a target audience. In an embodiment, the marker/trigger unit 224 can also trigger or initiate the campaign by providing a scheduling framework for execution of the synchronization system 110. The icon integration unit 226 can receive a message from the marker/trigger unit 224 indicating that an identified broadcast can be integrated with an icon or with a message that can include a unique identifier. In an embodiment, the icon integration unit 226 can use one of the several products available for integrating the broadcast with the icon, such as watermarking or fingerprinting technologies.

The front-end transmission unit 228 can receive a message from the marker/trigger unit 224 indicating that a broadcast that is integrated with the icon can be transmitted to a front-end broadcast device 122, such as a computer monitor, a widescreen television display or a stadium display screen during a certain interval of time. The user device transmission unit 230 can receive a message from the marker/trigger unit 224 indicating that a message including the icon can be transmitted to a selected group of user devices 108 respectively associated with the target audience or users 104 during the same time interval as the transmission from the marker/trigger unit 224 to the front-end broadcast device 122. In an embodiment, the icon that is included in the message can be a joiz Red Button™ that the user 104 can click on the Red Button™ to trigger a response in view of the broadcast that is integrated with the icon and presented on the front-end broadcast device 122. Therefore, the presentation of the broadcast that is integrated with the icon on the front-end broadcast device 122 can be synchronized with the transmission of the message including the icon to the user devices 108.

The user device response receiving unit 232 can receive, from the user devices 108, a response to the message including the icon. In an embodiment, the user 104 can click on the icon to trigger the response in conjunction with viewing the transmitted broadcast integrated with the icon on the front-end broadcast device 122. The response, or meta-data of the response, can be stored by the user and analytics database interface unit 234. In an embodiment, the user and analytics database interface unit 234 can determine an appropriate reward for the user 104 based on the response and instruct the user device transmission unit 230 to transmit, to the respective user device 108, a message indicating the reward.

In an embodiment, the user device response receiving unit 232 can receive a message indicating that a user device 108 has activated an application associated with the campaign. The message can be stored by the user and analytics database interface unit 234. In an embodiment, the user device transmission unit 230 can refer to the user and analytics database interface unit 234 to determine the user devices 108 to transmit the message including the icon.

FIG. 3 is an example flow diagram illustrating a method 300 for enabling the synchronization of devices across different media platforms in accordance with embodiments of the present disclosure. Method 300 may be performed by processing logic that may comprise hardware (e.g., circuitry, dedicated logic, programmable logic, microcode, etc.), software (such as instructions run on a processing device), firmware, or a combination thereof. In one implementation, method 300 is performed by the script compiling, signing, and packaging system 120 described with respect to FIG. 1.

Method 300 begins at block 305 and proceeds to block 310, where the synchronization system 110 can receive, by a processing device, a broadcast. As discussed above, a broadcast can be a media presentation such as a TV broadcast signal, a streaming video or audio presentation from a web site, a cinema presentation, a video presentation at a public event, and the like. Subsequently, at block 315, the synchronization system 110 can associate the received broadcast with a front-end broadcast device 122 and a time interval. As used herein, a front-end broadcast device 122 can be any device that can play the broadcast, such as a loudspeaker, a video monitor, a widescreen television monitor, or a commercial video board. As used herein, a time interval can be any duration of time. In an embodiment, the time interval can have a definite start and end time.

Next, at block 320, the synchronization system 110 can transmit the broadcast to a front-end broadcast device 122 during the time interval. The front-end broadcast device 122 can play the broadcast upon receipt. At block 325, the synchronization system 110 can transmit a message to a user device 108 that is associated with a user 104 during the time interval. As such, the synchronization system 110 effectively synchronizes the transmission of the broadcast to the front-end broadcast device 122 with the transmission of the message to the user device 108.

At block 330, the synchronization system 110 can receive a response to the message from the user device 108 during the time interval. In an embodiment, the response from the user device 108 can indicate that the user 104 has seen or heard the broadcast that was played on the front-end broadcast device 122. At block 335, the synchronization system 110 can determine a match between the response from the user device 108 and the broadcast that was played on the front-end broadcast device 122.

The determination of a match between the response from the user device 108 and the broadcast that was played on the front-end broadcast device 122 can be based on different factors. In one example, the match can be determined based on the time interval. If the response from the user device 108 is received within the same time interval that is associated with the broadcast that was played on the front-end broadcast device 122, then the synchronization system 110 can determine the match.

In another example, the match can be determined based on a unique identifier. As discussed above, the broadcast a message can include a unique identifier. In an embodiment, the front-end broadcast device 122 can play the broadcast with the included unique identifier. Upon viewing or hearing the broadcast, the user 104 can include the unique identifier in the response from the user device 108. This enables the synchronization system 110 to determine a match based on the unique identifier.

In another example, the match can be determined based on the geographical location of the user device 108. In an embodiment, the response from the user device 108 can include the current GPS coordinates of the user device 108 that is associated with a user 104. This enables the synchronization system 110 to determine a match based on the geographical location of the user device 108.

In another example, the match can be determined based on an application that has been activated by a user device 108. In an embodiment, the user device 108 can activate an application that may be related to the broadcast. When the user device 108 activates the application, the user device 108 can transmit a message to the synchronization system 110 indicating that the user device 108 has activated an application associated with the broadcast. In response to receiving the message indicating that the user device 108 has activated an application associated with the broadcast, the synchronization system 110 can transmit the message to the user device 108 during the time interval, based on the message indicating that the user device 108 has activated an application associated with the broadcast. This enables the synchronization system 110 to determine the match between the response received from the user device 108 and the transmitted broadcast based on the application that was activated on the user device 108.

Next, at block 340, the synchronization system 110 can determine an appropriate feedback message to the user device 108 based on the response received from the user device 108. In an embodiment, the feedback message can include an appropriate reward for the user 104, an informational message, an audio message, a video message, and the like. In another embodiment, the synchronization system 110 can determine the feedback message to the user device 108 based on a profile for the user 104 and the respective user device 108. The user profile can indicate certain preferences of the user 104. This enables the synchronization system 110 to determine the appropriate feedback message. In an embodiment, the response received from the user device 108 can include information to be updated in the user profile, such as the event associated with the response or a user preference that is identified in the response. In an embodiment, the synchronization system 110 can update the user profile based on the response. At block 345, the synchronization system 110 can transmit the feedback message to the user device 108, and the method 300 ends at block 350.

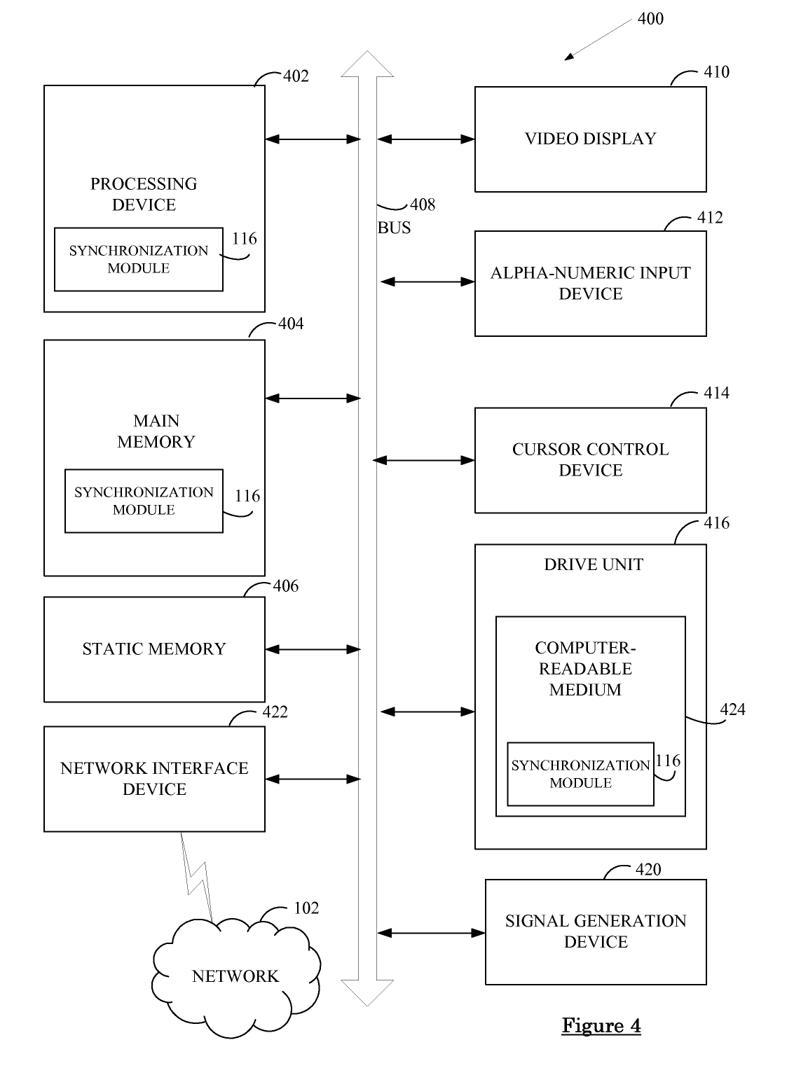

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device (processor) 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 408.

Processing device 402 represents one or more general-purpose processing devices such as a microprocessor, central processing unit, and the like. More particularly, the processing device 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein.

The computer system 400 may further include a network interface device 422. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 420 (e.g., a speaker).

The data storage device 418 may include a computer-readable storage medium 424 on which is stored one or more sets of instructions (e.g., Synchronization Module 116) embodying any one or more of the methodologies or functions described herein. The Synchronization Module 116 may also reside, completely or at least partially, within the main memory 404 and/or within the processing device 402 during execution thereof by the computer system 400, the main memory 404 and the processing device 402 also constituting computer-readable storage media. The instructions 430 may further be transmitted or received over a network 403 via the network interface device 422.

While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “associating”, “transmitting”, “determining”, “generating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

What is claimed is:

1. A method comprising:
receiving, by a processing device, a broadcast;
associating, by the processing device, the broadcast with a broadcast device and a time interval;
transmitting, by the processing device, the broadcast to the broadcast device during the time interval;
transmitting, by the processing device, a first message to a user device during the time interval;
receiving, by the processing device, a response to the first message from the user device during the time interval; and
determining, by the processing device, a match between the response and the transmitted broadcast.

2. The method of claim 1, wherein the user device and the broadcast device are different.

3. The method of claim 1, further comprising:
determining, by the processing device, the match between the response and the transmitted broadcast based on the time interval.

4. The method of claim 1, further comprising:
determining, by the processing device, the match between the response and the transmitted broadcast based on a unique identifier comprised in the response.

5. The method of claim 4, wherein the broadcast comprises the unique identifier.

6. The method of claim 1, further comprising:
transmitting, by the processing device, the first message to the user device during the time interval based on a geographical location of the user device; and
determining, by the processing device, the match between the response and the transmitted broadcast based on the geographical location of the user device.

7. The method of claim 1, further comprising:
receiving, by the processing device, a second message indicating that the user device has activated an application associated with the broadcast;
transmitting, by the processing device, the first message to the user device, during the time interval, based on the second message indicating that the user device has activated an application associated with the broadcast; and
determining, by the processing device, the match between the response and the transmitted broadcast based on the activated application.

8. The method of claim 1, further comprising:
determining, by the processing device, a feedback message based on the response; and
transmitting, by the processing device, to the user device, the feedback message.

9. The method of claim 8, wherein the feedback message is at least one of a reward, an informational message, an audio message, or a video message.

10. The method of claim 9, wherein the feedback message is based on a user profile associated with the user device.

11. The method of claim 1, further comprising:
transmitting, by the processing device, the first message to the user device during the time interval, based on a user profile associated with the user device; and
updating the user profile based on the response.

12. The method of claim 1, wherein the broadcast is at least one of a standard television broadcast signal, a digital broadcast signal, a satellite broadcast signal, a web site streaming broadcast signal, a closed-circuit broadcast signal, a cinema broadcast signal, an audio broadcast signal, a display of a message, a display of an icon, an internet-protocol (IP) television signal, an IP video signal, an IP audio signal, a video broadcast signal, or a progressive download streaming signal.

13. The method of claim 1, wherein the broadcast device is at least one of a loudspeaker, a video monitor, a television monitor, or a commercial video board.

14. The method of claim 1, further comprising:
integrating, by the processing device, the broadcast with an icon prior to transmitting to the broadcast device.

15. A system comprising:
a memory; and
a processing device, coupled to the memory, the processing device to:
receive a broadcast,
associate the broadcast with a broadcast device and a time interval,
transmit the broadcast to the broadcast device during the time interval,
transmit a first message to a user device during the time interval,
receive a response to the first message from the user device during the time interval, and
determine a match between the response and the transmitted broadcast.

16. The system of claim 15, further comprising:
determine the match between the response and the transmitted broadcast based on the time interval.

17. The system of claim 15, further comprising:
determine the match between the response and the transmitted broadcast based on a unique identifier comprised in the response.

18. A non-transitory computer-readable storage medium including instructions that, when accessed by a processing device, cause the processing device to execute operations comprising:
receiving, by the processing device, a broadcast;
associating, by the processing device, the broadcast with a broadcast device and a time interval;
transmitting, by the processing device, the broadcast to the broadcast device during the time interval;
transmitting, by the processing device, a first message to a user device during the time interval;
receiving, by the processing device, a response to the first message from the user device during the time interval; and
determining, by the processing device, a match between the response and the transmitted broadcast.

19. The non-transitory computer-readable storage medium of claim 18, further comprising:
determining, by the processing device, the match between the response and the transmitted broadcast based on the time interval.

20. The non-transitory computer-readable storage medium of claim 18, further comprising:
determining, by the processing device, the match between the response and the transmitted broadcast based on a unique identifier comprised in the response.
